(19) United States
(12) Patent Application Publication
(10) Pub. No.: US 2006/0164349 A1
(43) Pub. Date: Jul. 27, 2006

(54) Liquid crystal display module having rigid-flexible printed circuit board

(75) Inventor: Guo-Liang Hu, Shenzhen (CN)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/317,116

(22) Filed: Dec. 23, 2005

(30) Foreign Application Priority Data
Jan. 21, 2005 (TW) 94201148

(51) Int. Cl. G09G 3/34

(52) U.S. Cl. 345/84

(57) ABSTRACT

An LCD module (2) includes a frame (230) having a first containing space (231) and a second containing space (232), a light guide plate (240) received in the first containing space, an LCD panel (220) disposed on the light guide plate, a rigid-flexible printed circuit board (210) electrically connecting to the LCD panel, and at least a light emitting diode (200) electrically connecting to the rigid-flexible printed circuit board. The rigid-flexible printed circuit board includes at least one rigid circuit region (211), and the light emitting diode is provided at the rigid circuit region. The rigid circuit region is received in the second containing space.

### FIELD OF THE INVENTION

The present invention relates to liquid crystal display modules, and more particularly to a liquid crystal display module having a rigid-flexible printed circuit board.

### BACKGROUND

Liquid crystal display (LCD) devices have been widely used in notebooks, personal digital assistants (PDAs), cellular phones, and other electronic products because the price of LCDs is low and the quality of LCDs is generally high. LCDs are passive optical devices. Therefore, in general, a frontlight module or a backlight module needs to be attached to the LCD panel of the LCD device. The frontlight or backlight module provides sufficient illumination to make the LCD device visible at night and display images in full color. Generally, the backlight module includes a light source and a diffusion sheet. The backlight module is usually attached below the LCD panel. The light source provides primary light beams, which are dispersed by the diffusion sheet to become uniform light beams. The uniform light beams are transmitted to the LCD panel to display an image.

Conventionally, a light source for backlight modules is usually one of two types. The first type is a cold cathode fluorescence lamp (CCFL), and the second type is a light emitting diode (LED). CCFLs have relatively greater luminescent efficiency, but are larger and consume more electricity than LEDs. Therefore, the CCFL is generally only suitable for a large sized multicolored display requiring high brightness levels. Though the luminescent efficiency of an LED is lower than that of a CCFL, the LED has some advantages. For example, the size of the LED is smaller, the emitted light of the LED is more focused, and the working lifetime of the LED is longer. In addition, even when the LED wears out and is discarded, the LED causes less pollution. Therefore, the LED is suitable for a monochromatic, electrically efficient, small sized product. For example, the LED can be used in an LCD panel of a cellular phone or an LCD panel of a vehicular satellite navigation system.

Referring to FIG. 7, a conventional LCD module 1 includes a flexible printed circuit board 110, an LCD panel 120, a frame 130, a light guide plate 140, and two light emitting diodes 100.

The flexible printed circuit board 110 defines a light source region 111 that includes the light emitting diodes 100, and a main circuit region 112 electrically connected to the LCD panel 120 for driving the LCD panel 120. The frame 130 includes a first containing space 131 and a second containing space 132. The light guide plate 140 is received in the first containing space 131, and the light emitting diodes 100 of the light source region 111 are received in the second containing space 132.

In assembly, the flexible printed circuit board 110 is folded over into the first containing space 131 of the light guide plate 140. Then the LCD panel 120 is rotated up and attached into the frame 130. In use, the flexible printed circuit board 110 drives the light emitting diodes 100 to emit light beams, the light beams emitted by the light emitting diodes 100 transmit into the light guide plate 140 and are converted to a surface light source, and the surface light source illuminates the LCD panel 120.

However, the light emitting diodes 100 are arranged at the light source region 111 of the flexible printed circuit board 110, and the light source region 111 is adhered to the frame 130. The connection between the light emitting diodes 100 and the frame 130 is vulnerable to displacement when the LCD module 1 is subjected to vibration or shock. If the light emitting diodes 100 are displaced, this causes loss of some of the light beams emitted therefrom. This in turn diminishes the display characteristics of the LCD module 1.

What is needed is an LCD module that can overcome the above-described problems.

### SUMMARY

A liquid crystal display module includes a frame having a first containing space and a second containing space, a light guide plate received in the first containing space, an LCD panel disposed on the light guide plate, a rigid-flexible printed circuit electrically connecting to the LCD panel, and at least one light emitting diode electrically connecting to the rigid-flexible printed circuit board. The rigid-flexible printed circuit board includes at least one rigid circuit region, and the light emitting diode is provided at the rigid circuit region. The rigid circuit region is received in the second containing space.

In an exemplary embodiment, two light emitting diodes are disposed at two rigid circuit regions of the rigid-flexible printed circuit board respectively. The second containing space comprises two recesses receiving the rigid circuit regions. Each rigid circuit region has a rigidity greater than that of the flexible main circuit region. Therefore, the rigid circuit regions can be more tightly attached in the recesses. This helps prevent the light emitting diodes from being displaced when the LCD module is subjected to vibration or shock.

Other advantages and novel features will become more apparent from the following detailed description when taken in conjunction with the accompanying drawings.

### BRIEF DESCRIPTION OF THE DRAWINGS

FIG. 1 is an isometric view of an LCD module according to a preferred embodiment of the present invention, the LCD module including a rigid-flexible printed circuit board, a frame, and a light guide plate.

FIG. 2 is an enlarged, top, flattened view of the rigid-flexible printed circuit board of FIG. 1.

FIG. 3 is a side view of the rigid-flexible printed circuit board of FIG. 2.

FIG. 4 is an enlarged, top view of the frame of FIG. 1.

FIG. 5 is an enlarged, top view of the light guide plate of FIG. 1.

FIG. 6 is an enlarged, schematic, top flattened view of the LCD module of FIG. 1.

FIG. 7 is a top view of a conventional LCD module prior to assembly thereof.

### DETAILED DESCRIPTION OF PREFERRED EMBODIMENTS

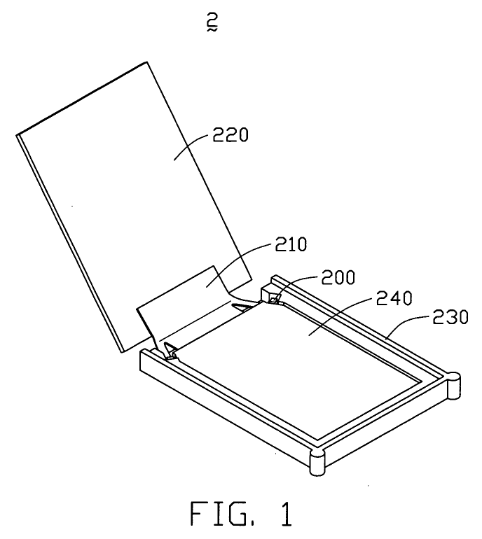

Referring to FIG. 1, an LCD module 2 according to a preferred embodiment of the present invention includes a rigid-flexible printed circuit board 210, an LCD panel 220, a frame 230, a light guide plate 240, and two light emitting diodes 200.

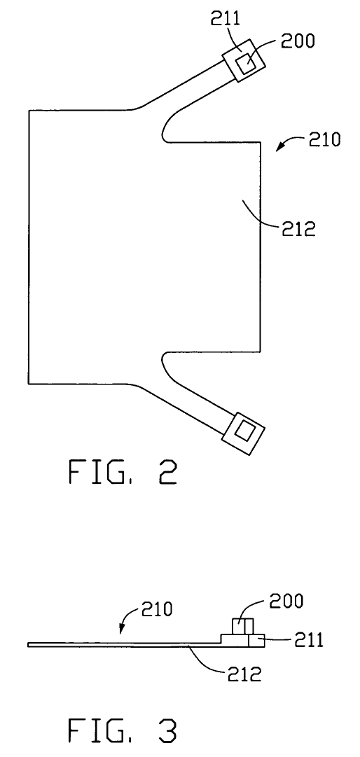

Referring also to FIGS. 2 and 3, the rigid-flexible printed circuit board 210 includes two rigid circuit regions 211 and a flexible main circuit region 212. The flexible main circuit region 212 has two arms (not labeled) extending therefrom. Ends of the arms are electrically connected to conductive layers of the rigid circuit regions 211 respectively. Two light emitting diodes 200 are soldered to the rigid circuit regions 211 respectively.

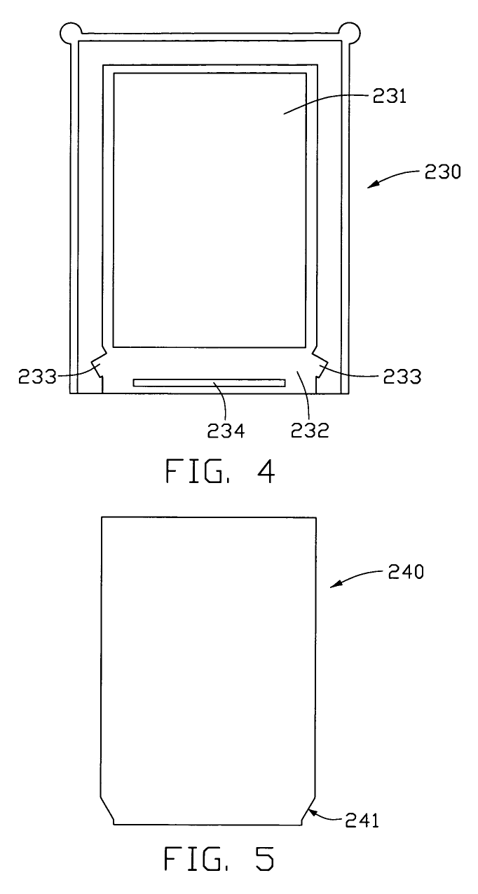

Referring to FIG. 4, the frame 230 includes a first containing space 231 and a second containing space 232. The first containing space 231 is for accommodating the light guide plate 240 and the LCD panel 220. The second containing space 232 includes a central strip-shaped slot 234, and two opposite end recesses 233.

Referring to FIG. 5, the light guide plate 240 includes two opposite oblique portions 241 respectively at two corners of one end thereof. The oblique portions 241 correspond to the recesses 233 of the frame 230.

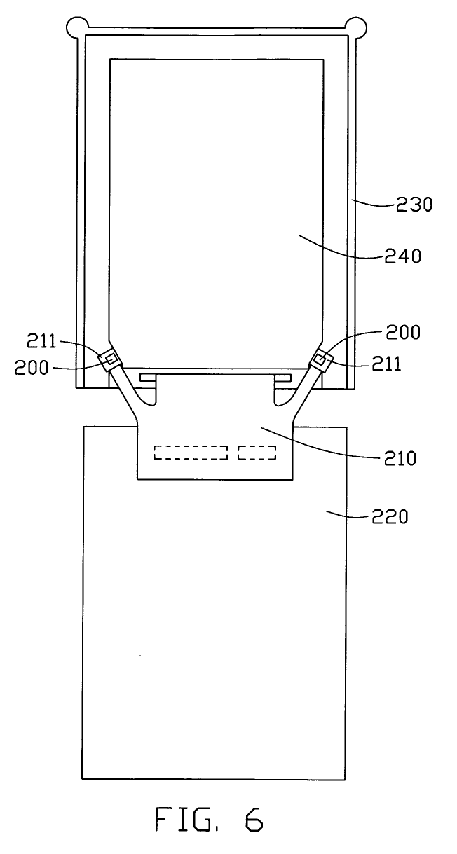

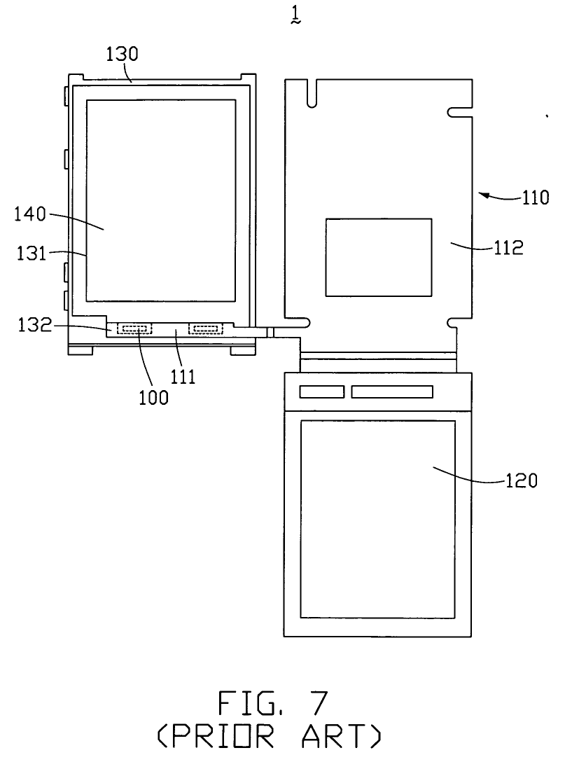

Referring to FIG. 6, in assembly, the light guide plate 240 is received in the containing space 231. Then, one end of the flexible main circuit region 212 is electrically connected and fixed to the LCD panel 220, and an opposite end of the flexible main circuit region 212 is inserted into the slot 234. The rigid circuit regions 211 are received and fixed in the recesses 233 adjacent to the oblique portions 241 of the light guide plate 240 respectively. Finally, the LCD panel 220 is rotated up and pressed down into the first containing space 231. In this process, the flexible main circuit region 212 is folded over.

In use, the rigid-flexible printed circuit board 210 drives the light emitting diodes 200 to emit light beams. The light beams travel to the light guide plate 240, which converts the light beams to a surface light source. The surface light source illuminates the LCD panel 220.

With this configuration, the rigid-flexible printed circuit board 210 has the characteristics of both a rigid and a flexible printed circuit board. The light emitting diodes 200 are disposed at the rigid circuit regions 211 of the rigid-flexible printed circuit board 210, which are stably held in the recesses 233 of the second containing space 232 of the frame 230. Each rigid circuit region 211 has a rigidity greater than that of the flexible main circuit region 212. Therefore the rigid circuit regions 211 can be more tightly attached in the recesses 233. This helps prevent the light emitting diodes 200 from being displaced when the LCD module 2 is subjected to vibration or shock. Moreover, the light emitting diodes 200 are located closely adjacent the oblique portions 241 of the light guide plate 240. Therefore most if not all of the light beams emitted by the light emitting diodes 200 enter the light guide plate 240, which enables the LCD module 2 to have higher brightness and better display characteristics.

It is to be understood, however, that even though numerous characteristics and advantages of the present embodiments have been set out in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A liquid crystal display module, comprising:
a frame comprising a first containing space and a second containing space;
a light guide plate received in the first containing space;
a liquid crystal display panel disposed on the light guide plate;
a rigid-flexible printed circuit board electrically connected to the liquid crystal display panel, the rigid-flexible printed circuit board defining at least one rigid circuit region; and
at least one light emitting diode provided at the rigid circuit region, the rigid circuit region being received in the second containing space.

2. The liquid crystal display module as claimed in claim 1, wherein the at least one rigid circuit region is two separate rigid circuit regions, and the rigid-flexible printed circuit board further defines a flexible main circuit region.

3. The liquid crystal display module as claimed in claim 2, wherein the flexible main circuit region has two arms extended therefrom, and the arms are electrically connected to the rigid circuit regions respectively.

4. The liquid crystal display module as claimed in claim 3, wherein the at least one light emitting diode is two light emitting diodes, which are provided at the rigid circuit regions respectively.

5. The liquid crystal display module as claimed in claim 2, wherein one end of the flexible main circuit region is electrically connected to the liquid crystal panel.

6. The liquid crystal display module as claimed in claim 1, wherein the second containing space defines a slot therein.

7. The liquid crystal display module as claimed in claim 6, wherein one end of the flexible main circuit region is received in the slot.

8. The liquid crystal display module as claimed in claim 1, wherein the second containing space defines at least one recess.

9. The liquid crystal display module as claimed in claim 8, wherein the rigid circuit region is received in the recess.

10. The liquid crystal display module as claimed in claim 1, wherein the light guide plate defines at least one oblique portion.

11. The liquid crystal display module as claimed in claim 10, wherein the light emitting diode is adjacent to the oblique portion.
